(19) United States
(12) Patent Application Publication
(10) Pub. No.: US 2008/0049010 A1
(43) Pub. Date: Feb. 28, 2008

(54) PLASMA DISPLAY DEVICE AND METHOD OF DRIVING THE SAME

(75) Inventor: Byung Joon RHEE, Yongin Si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/932,700

(22) Filed: Oct. 31, 2007

Related U.S. Application Data
(63) Continuation of application No. 11/617,499, filed on Dec. 28, 2006.

(30) Foreign Application Priority Data
Dec. 28, 2005 (KR) 10-2005-0131959

(51) Int. Cl. G09G 5/00

(52) U.S. Cl. 345/211; 345/205

(57) ABSTRACT

Disclosed herein is a plasma display device and a method of driving the plasma display device. In the method of driving the plasma display device, the plasma display device includes sustain electrodes and scan electrodes formed in parallel with each other, and ITO electrodes are spaced apart from each other by an interval of a gap between the ITO electrodes which is a predetermined value or more. The plasma display panel is separately driven in a reset period, an address period, and a sustain period. In the method, a sustain pulse is alternately applied to the sustain electrodes and the scan electrodes during the sustain period. After the sustain pulse has been applied, a predetermined region in the sustain pulse is floated in order to remove an oscillation discharge occurring after a main discharge is performed. Such an approach can prevent the luminescence characteristics of a phosphor from being deteriorated due to the distortion of the sustain pulse.

### BACKGROUND

1. Technical Field

The present invention relates, in general, to a plasma display device and method of driving the plasma display device and, more particularly, to a plasma display device and method of driving the plasma display device, which can prevent the luminescence characteristics of a phosphor from being deteriorated.

2. Description of the Related Art

A Plasma Display Panel (hereinafter referred to as a ‘PDP’) is a device that excites a phosphor using vacuum ultraviolet rays generated by a gaseous discharge for displaying an image using visible rays generated from the phosphor. A PDP is advantageous in that it is thin and light compared to a Cathode Ray Tube (CRT), which is one of the most popular display devices that were previously developed, and in that it is capable of forming a high definition large screen.

A PDP is composed of a plurality of discharge cells arranged in the form of a matrix. A single charge cell forms a single sub-pixel on a screen, and three adjacent sub-pixels, corresponding respectively to Red (R), Green (G) and Blue (B), constitute a single pixel.

FIG. 1 illustrates a perspective view showing the structure of a conventional 3-electrode surface discharge-type Alternating Current (AC) PDP. Referring to FIG. 1, the conventional PDP includes an upper plate 1 and a lower plate 2.

The upper plate 1 includes a plurality of sustain electrodes Z and scan electrodes Y which are patterned on a plate glass in parallel with each other, an upper dielectric layer 8 in which wall charges, generated during a plasma discharge, are accumulated, and a protective layer 9 for preventing damage to the upper dielectric layer 8 from occurring due to sputtering generated during a plasma discharge, and improving the discharge efficiency of secondary electrons.

Each of the sustain electrodes Z and the scan electrodes Y is composed of a wide linear transparent electrode (not shown), which is implemented using an Indium-Tin Oxide (ITO) thin film, and a narrow linear bus electrode (not shown), which is implemented using a thin metal film made of at least one of Ag, Cu and Cr. The bus electrode is generally located far away from the surface discharge gap of the transparent electrode. The PDP employs such an electrode structure to minimize light shielding and to widen a surface discharge area, thus improving luminescence efficiency.

The lower plate 2 includes a plurality of address electrodes X arranged to intersect the sustain electrodes Z and the scan electrodes Y, a plurality of barrier ribs 3 for partitioning respective discharge cells, a phosphor 4 applied on the side walls and bottom surfaces of the barrier ribs 3 in parallel with the address electrodes X to emit visible rays, and a lower dielectric layer 5 for covering the address electrodes X to function as a reflective layer.

The upper plate 1 and the lower plate 2 of the panel are attached to each other. The barrier ribs 3 form a plurality of discharge cells, each of which has a discharge space. The discharge cells are formed around the regions at which the sustain electrodes Z and the scan electrodes Y of the upper plate 1 of the panel intersect the address electrodes X of the lower plate 2 as the upper and lower plates 1 and 2 are attached. The inside of the attached panels is vacuum exhausted, and the discharge space between the upper plate 1 and the lower plate 2 is filled with a binary or ternary inert gas, for example, an inert gas including a Xenon (Xe) gas.

The 3-electrode surface discharge-type PDP having the above structure is driven by the following process. First, address discharge occurs between the scan electrodes Y and the address electrodes X, and thus wall charges are accumulated on the surfaces of respective electrodes. Then, the phosphor 4 is excited using vacuum ultraviolet rays generated due to the sustain discharge between the scan electrodes Y and the sustain electrodes Z, thus exposing visible rays from the phosphor 4 to the outside of the panel through the upper plate 1.

In the above-mentioned driving method of a 3-electrode surface discharge-type AC PDP, in order to represent the gray levels of an image, a single frame is divided into a plurality of sub-fields having different numbers of luminescence operations and the sub-fields are driven in a time division manner. Each sub-field is divided into an initialization period R for performing uniform discharge, an address period (or a write period) W for selecting a discharge cell, and a sustain period (a discharge sustain period) S during which cells selected during the address period emit lights. The sub-fields forming a frame generally have different lengths of sustain period and the gray level of a pixel is represented by a combination of various sub-fields during which the cell emits light.

For example, in order to display an image using 256 gray levels, a frame period (16.66 ms) corresponding to 1/60 second is divided into eight sub-fields SF1 to SF8, as shown in FIG. 2. FIG. 2 illustrates the structure of an image field consisting of eight sub-fields of varying lengths. Further, each of the eight sub-fields SF1 to SF8 is divided again into a reset period, an address period and a sustain period. In this example, the reset and address periods of respective sub-fields are identical to each other, whereas sustain periods thereof increase at the rate of 2ⁿ (n=0, 1, 2, 3, 4, 5, 6, and 7). That is, the lengths of the eight sustain periods in the eight sub-fields correspond to 2⁰, 2¹, 2², 2³, 2⁴, 2⁵, 2⁶, and 2⁷, respectively. In this way, by combining the various lengths of the sustain periods, 256 gray levels of an image can be represented.

In the above implementation, during the reset period, reset pulses are provided to the scan electrodes Y, and thus reset discharge occurs. During the address period, scan pulses are provided to the scan electrodes Y, and data pulses are applied to the address electrodes X. The voltage difference between the scan pulse and the data pulse is added to the wall voltage generated during the reset period, thus address discharge occurs in a cell to which the data pulse is applied. During the address discharge, wall charges are formed on the dielectric layers 8 and 5 of the upper plate 1 and lower plate 2, respectively. During the sustain period, a sustain pulse is alternately applied to all scan electrodes Y and sustain electrodes Z. Then, in the cell where address discharge occurred, a sustain discharge occurs in the form of surface discharge between the sustain electrodes Z and the scan electrodes Y whenever the sustain pulse is applied while the wall voltage of the cell is added to the sustain pulse.

A high voltage of more than several hundred volts is required for the address discharge and the sustain discharge of the surface discharge-type AC PDP driven as explained above. Therefore, in order to minimize the driving power required for the address discharge and sustain discharge, an energy recovery circuit (or a sustain discharge circuit) is used. The sustain discharge circuit recovers or stores the voltage between the sustain electrodes Z and the scan electrodes Y, and uses the recovered or stored voltage as a driving voltage for a subsequent discharge operation.

FIG. 3 illustrates a circuit diagram of an example sustain discharge circuit for a plasma display panel. A sustain discharge circuit 20 for a sustain electrode Z and a sustain discharge circuit 30 (not shown in detail) for a scan electrode Y are generally constructed to be identical to each other. Hereinafter, for convenience of description, a sustain discharge circuit for only a single electrode is described.

Referring to FIG. 3, the sustain discharge circuit 20 includes an energy recovery unit composed of two switches S1 and S2, diodes D1 and D2, and an energy recovery capacitor Cc, and a sustain discharge unit composed of two switches S3 and S4 connected in series. An inductor Lc is disposed between the diodes D1 and D2 of the energy recovery unit and the two switches S3 and S4 of the sustain discharge unit. A load represented by a capacitor Cp of the plasma display panel is connected to the sustain discharge unit. Some other minor components are omitted in the drawing.

FIG. 4 illustrates an ideal voltage waveform of an electrode driven by the sustain discharge circuit of FIG. 3. As shown, the sustain discharge circuit operates in four modes depending on the switching status of the switches S1 to S4, and the waveform of an output voltage Vp varies accordingly. In the initial state or in mode 4, since only the switch S4 is turned on, the voltage Vp at both ends of the panel is maintained at 0 V. At this time, the energy recovery capacitor Cc may have been pre-charged to a voltage (e.g., Vs/2) that is half or some other portion of an externally applied voltage Vs so as to prevent inrush current from being generated when a sustain discharge starts. At time point t0, while the voltage Vp at both ends of the panel is maintained at 0V, an operation in mode 1, in which the switch S1 is turned on and the switches S2, S3 and S4 are turned off, starts.

During the operating interval in mode 1 (t0˜t1), an LC resonance circuit is formed by the path formed through the energy recovery capacitor Cc, the switch S1, the diode D1, the inductor Lc, and the plasma display panel capacitor Cp, such that current I_{L} flows through the inductor Lc, and the voltage Vp of the panel increases.

After the operation in mode 1 has been completed, an operation in mode 2, in which the switch S3 is turned on, and the switches S1, S2 and S4 are turned off, starts. During mode 2 (t1˜t2), the externally applied voltage Vs charges the panel capacitor Cp via the switch S3, thus maintaining the voltage VP of the panel at the level of Vs.

If the operation in mode 2 has been completed, an operation in mode 3, in which the switch S2 is turned on, and the switches S1, S3 and 54 are turned off, starts. During mode 3 (t2˜t3), the switch S2 is turned on and the switches S1, S3 and S4 are turned off. Thus, an LC resonance circuit is formed by a path formed through the plasma display panel capacitor Cp, the inductor Lc, the diode D2, the switch S2, and the energy recovery capacitor Cc. The output voltage Vp of the panel decreases, as the plasma display panel capacitor Cp charges the energy recovery capacitor Cc.

During the operating interval in mode 4 (t3˜t4), the switch S4 is turned on, and the switches S1, S2 and S3 are turned off. Thus, the output voltage Vp of the panel is maintained at 0V.

Then, the switch S1 is turned on again, and the switches S2, S3 and S4 are turned off, the process returns to the operation in mode 1, and the entire cycle is repeated.

However, the conventional method as explained above has the problem of waveform distortion, which causes the deterioration of the luminescence characteristics of the phosphor. FIG. 5 illustrates an actual voltage waveform of an electrode driven by the sustain discharge circuit diagram as explained above. If sustain discharge starts between the sustain electrode Z and the scan electrode Y, the capacitance of the PDP rapidly and substantially increases, and the resonant frequency of the sustain discharge circuit consequently changes, and thus distortion occurs, as shown in FIG. 5. Such distortion causes a problem in that the number of charged particles moving toward a phosphor increases in proportion to the interval of the gap between ITO electrodes, thus deteriorating the luminescence characteristics of the phosphor.

### SUMMARY

In one general aspect, an improved plasma display device and method of driving the plasma display device can prevent an increase in the number of charged particles moving toward a phosphor after a main discharge is performed, thus preventing the luminescence characteristics of the phosphor from being deteriorated.

To this end, a plasma display device includes a plurality of sustain electrodes and scan electrodes, formed in parallel with each other and provided with respective Indium-Tin Oxide (ITO) electrodes, and a plurality of barrier ribs, wherein the plasma display device is constructed to apply a sustain pulse for a sustain discharge to the sustain electrodes or the scan electrodes during a sustain period, and the sustain pulse comprises a pulse waveform that is floated for a second time period after a first time period has elapsed from a time point at which a voltage of the sustain pulse increases from a first voltage to a second voltage.

The barrier ribs and the ITO electrodes may satisfy a condition that a relationship between a height D of the barrier ribs and an interval d of a gap between the ITO electrodes is 1/D²≧1/d².

The ITO electrodes may be spaced apart from each other by an interval of a gap between the ITO electrodes which is 80 μm or more.

Floating of the sustain pulse may be implemented by turning off all of a plurality of switch devices provided in a sustain discharge circuit.

In another general aspect, a method is provided for driving a plasma display device that includes a plurality of scan electrodes and sustain electrodes, formed in parallel with each other and provided with respective Indium-Tin Oxide (ITO) electrodes, and a plurality of barrier ribs. According to the method, the plasma display device is separately driven in a reset period, an address period, and a sustain period, with a sustain pulse for a sustain discharge being applied to the sustain electrodes or the scan electrodes during the sustain period. The method includes increasing a voltage of the sustain electrodes or the scan electrodes from a first voltage to a second voltage; supplying the second voltage to the sustain electrodes or the scan electrodes for a first time period; and floating the sustain electrodes or the scan electrodes for a second time period after the first time period has elapsed.

The floating step may be applied when a relationship between a height D of the barrier ribs and an interval d of a gap between the ITO electrodes is 1/D²≧1/d².

The floating step may be applied to a plasma display panel, in which the ITO electrodes are spaced apart from each other by an interval of a gap between the ITO electrodes, which is 80 μm or more.

The floating step may be performed by turning off a plurality of switching devices provided in a sustain discharge circuit.

In another general aspect, a method is provided for driving a plasma display device that includes a plurality of scan electrodes and sustain electrodes, formed in parallel with each other and provided with respective Indium-Tin Oxide (ITO) electrodes, and a plurality of barrier ribs. According to the method, the plasma display device is separately driven in a reset period, an address period, and a sustain period, with a sustain pulse for a sustain discharge being applied to the sustain electrodes or the scan electrodes during the sustain period. The method includes increasing a voltage of the sustain electrodes or the scan electrodes from a first voltage to a second voltage; and processing a predetermined region, which occurs after a main sustain discharge region, to be floated in order to eliminate an oscillation discharge caused by oscillation occurring after the voltage increases to the second voltage.

The floating processing step may be performed to float the sustain electrodes or the scan electrodes if a number of times that the scan pulse, which intersects the second voltage in a positive (+) or negative (−) direction, intersects the second voltage reaches a predetermined number.

The floating processing step may be performed to float the sustain electrodes or the scan electrodes if a number of times that the scan pulse, which intersects the second voltage in a positive (+) or negative (−) direction, intersects the second voltage reaches two.

Accordingly, the plasma display device and method described above may be used to prevent the number of charged particles, moving toward a phosphor after a main discharge is performed, from increasing, thus preventing the luminescence characteristics of the phosphor from being deteriorated.

Other features will be apparent from the following description, including the drawings, and the claims.

### BRIEF DESCRIPTION OF THE DRAWINGS

The above and other features and advantages will be more clearly understood from the following detailed description taken in conjunction with the accompanying drawings, in which:

FIG. 1 is a perspective view showing the structure of a 3-electrode surface charge-type plasma display panel;

FIG. 2 illustrates the structure of an image field consisting of eight sub-fields of varying lengths;

FIG. 3 is a circuit diagram of an example sustain discharge circuit for a plasma display panel;

FIG. 4 is an ideal voltage waveform of an electrode driven by the sustain discharge circuit of FIG. 3;

FIG. 5 is an actual voltage waveform of an electrode driven by the sustain discharge circuit showing an example of distortion occurring in a sustain pulse;

FIGS. 6A and 6B are section views of plasma display panel cells showing the gaps between electrodes;

FIG. 7 is an actual voltage waveform showing the distorted portion that will be eliminated; and

FIG. 8 is an actual voltage waveform of an electrode with some distortion removed.

### DETAILED DESCRIPTION

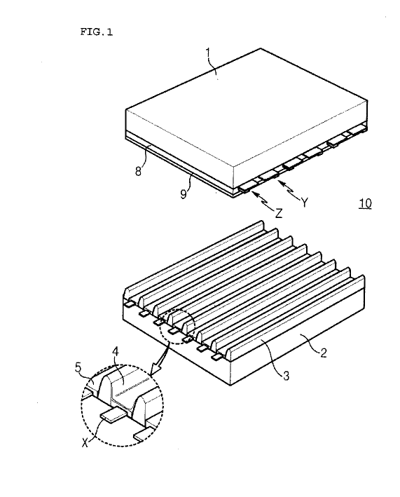

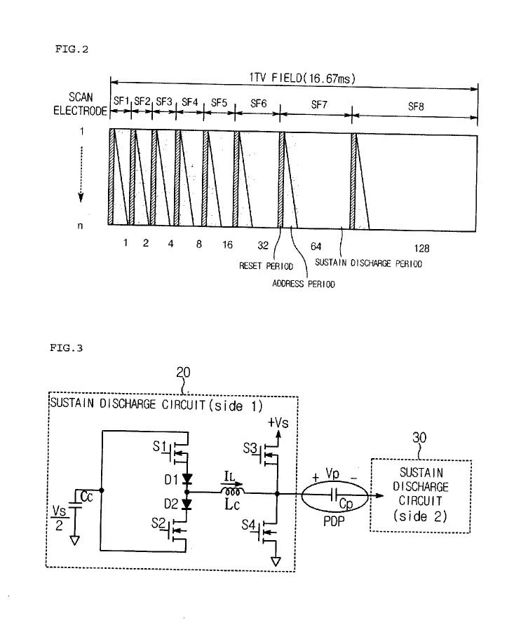

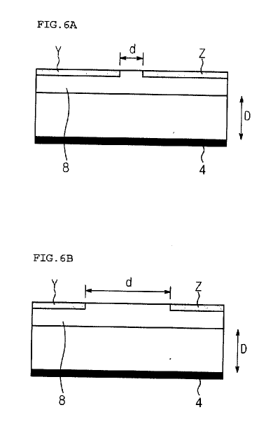

FIGS. 6A and 6B are section views of plasma display panel cells showing the gaps between ITO electrodes. A method of driving the plasma display panel is applied to cells, for example, as shown in FIGS. 6A and 6B. The same reference numerals are used throughout the different drawings to designate the same or similar components as those of FIG. 1, because the functions and operations thereof are the same.

When the relationship between the height of a discharge space, that is, the height D of a barrier rib, and the interval d of the gap between ITO electrodes is 1/D²<1/d², as shown in FIG. 6A, the behavior of particles is strong at an upper plate, and becomes weak toward a phosphor 4 from the upper plate.

On the contrary, when the relationship between the height D of the barrier rib and the interval d of the gap between the ITO electrodes is 1/D²≧1/d², as shown in FIG. 6B, the behavior of the particles becomes strong toward the phosphor 4. In particular, when the interval of the gap between ITO electrodes is 80 μm or more, the discharge load between the sustain electrode Z and the scan electrode Y increases further, and the distortion of the sustain pulse also increases. This distortion cause an oscillation discharge between the sustain electrode Z and the scan electrode Y, thus harming the phosphor 4, and consequently negatively influencing the afterimage, the lifespan and the uniformity of the PDP.

As explained above, the undesirable distortion of the sustain pulse increases as the gap between the ITO electrodes increases, especially when the gap exceeds 80 μm. Therefore, it is desirable to keep the gap between the ITO electrodes as small as possible.

However, a wide gap between the ITO electrodes is desirable for different reasons. For example, when the gap between ITO electrodes of the PDP is maintained at a wide interval, the luminance efficiency of the panel is improved due to the formation of a discharge region, such as a positive column region. Such improvements may be attained when the interval between the ITO electrodes, that is, the interval between the sustain electrode Z and the scan electrode Y, is at 80 μm or more.

One implementation provides a method of driving a plasma display device which reduces the undesirable distortion even when the gap between the ITO electrodes are large, even more than 80 μm. To this end, the method performs floating processing such that the electrode to which the discharge pulse is applied is placed in a floating state during the period when distortion occurs. The floating processing method is described below.

In an initial state or in mode 4, since only the switch S4 is turned on, the voltage Vp is maintained at 0V. In this case, the energy recovery capacitor Cc may be charged in advance to Vs/2, corresponding to ½ of the externally applied voltage Vs, thus preventing inrush current from being generated when a sustain discharge starts.

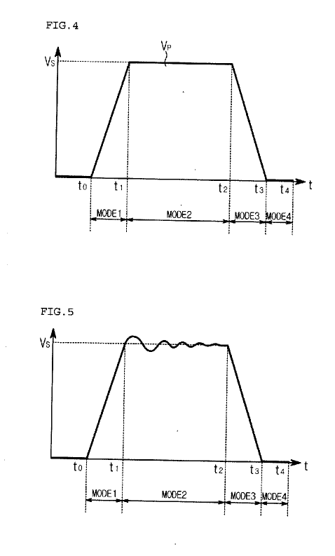

If a time point to arrives while the voltage Vp is maintained at 0V, the operation in mode 1, in which the switch S1 is turned on and the switches S2, S3 and S4 are turned off, starts, as previously described with reference to FIGS. 3 and 4. During mode 1 (t0˜t1), an LC resonance circuit is formed by the path formed through the energy recovery capacitor Cc, the switch S1, the diode D1, the inductor Lc, and the plasma display panel capacitor Cp, so that current I_{L} flows through the inductor Lc, and the output voltage Vp of the panel increases.

Then, at time point t1, an operation in mode 2, in which the switch S3 is turned on, and the switches S1, S2 and S4 are turned off, starts. During mode 2, the externally applied voltage Vs charges the panel capacitor Cp via the switch S3, and, ideally, the output voltage Vp is maintained at Vs.

However, in practice, since the capacitance of the PDP rapidly increases, a transient response occurs, as shown in FIG. 5. Such a transient response increases further as the interval between ITO electrodes increases. As the distortion of the sustain pulse caused by such a transient response is the cause of the deterioration of the luminescence characteristics of the phosphor, there is a need to eliminate an oscillation discharge.

Thus, according to one implementation, after the output voltage Vp becomes substantially equal to the externally applied voltage Vs in mode 2, all of the switches S1, S2, S3, and S4 are turned off, thus placing the associated electrode (one electrode of the capacitor Cp) in a floating state.

The exact timing to enter into the floating state may vary depending upon factors such as the period of the sustain pulse, the pulse width thereof, and the interval between ITO electrodes. The exact timing be suitably set using experimental results. However, the timing also may be determined otherwise. For example, the floating state may be invoked right after the output voltage Vp reaches the level of the externally applied voltage Vs. Alternatively, the floating state may be invoked after the oscillating voltage Vp crosses the voltage level Vs for a predetermined number of times.

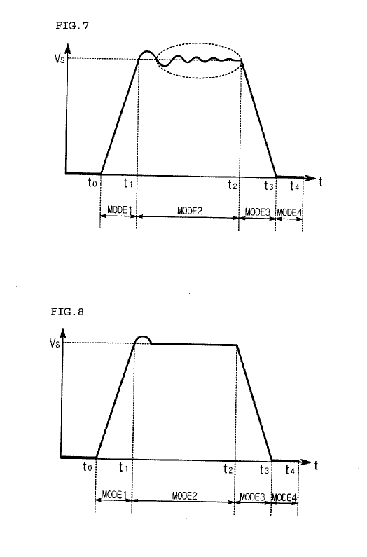

FIG. 8 illustrates a voltage waveform of the sustain pulse with some distortion removed according to one implementation. In this implementation, the floating state is entered right after the output voltage Vp crosses the voltage level VS twice. FIG. 7 shows, with dotted line, the waveform distortion that is removed according to this implementation. As oscillation discharge is prevented as explained above, charged particles can be prevented from moving toward the phosphor due to such an oscillation discharge, thereby preventing the deterioration of the luminescence characteristics of a phosphor.

After a certain period of time, the operation in mode 2 is completed while the output voltage Vp of the panel is maintained. Then, the operation in mode 3, in which the switch S2 is turned on and the switches S1, S3, and S4 are turned off, starts.

During mode 3 (t2˜t3), an LC resonance circuit is formed by a path formed through the plasma display panel capacitor Cp, the inductor Lc, the diode D2, the switch S2, and the energy recovery capacitor Cc, and the output voltage Vp of the panel decreases.

Then, once the capacitor Cc has been charged to a desired level, mode 4 begins. During mode 4 (t3˜t4), the switch S4 is turned on, and the switches S1, S2, and S3 are turned off, so that the panel output voltage Vp is maintained at 0V. Then, the switch S1 is turned on again, the process returns to the operation in mode 1, and the entire cycle is repeated.

As explained, the plasma display device and method of driving the plasma display panel can prevent the luminescence characteristics of the phosphor from being deteriorated due to the distortion of a sustain pulse, thus improving luminescence efficiency, increasing the lifespan of the panel, and improving the uniformity of the panel. Such improvements may result, for example, with a plasma display panel having a gap between ITO electrodes greater than or equal to 80 μm.

Accordingly, certain implementations of the described plasma display device and method of driving the plasma display panel can prevent the luminescence characteristics of a phosphor from being deteriorated due to the distortion of a sustain pulse, in an interval during which the sustain pulse is applied and is maintained at a sustain voltage, thus not only improving luminescence efficiency, but also increasing the lifespan of a plasma display panel and improving the uniformity of the panel.

Such implementations can obtain a remarkably excellent effect from the standpoint of the lifespan and luminescence efficiency of a panel when applied to a plasma display panel having a gap between ITO electrodes, which is 80 μm or more.

Other implementations are within the scope of the following claims.

What is claimed is:

1. A method of driving a plasma display device which comprises a plurality of scan electrodes and sustain electrodes, the method comprising:
supplying the pre-charged voltage in an energy recovery capacitor to a first electrode during an operating interval in mode 1, the first electrode being selected among the plurality of the scan electrodes and sustain electrodes; and
placing the first electrode in a floating state during an operating interval in mode 2 after the operation in mode 1.

2. The method of claim 1, wherein the first electrode is placed in the floating state for a predetermined period.

3. The method of claim 1, wherein the first electrode is placed in the floating state after the voltage level of the first electrode exceeds a predetermined value.

4. The method according to claim 1, wherein the floating step is performed to float the sustain electrodes or the scan electrodes if a number of times that the scan pluse, which intersects the second voltage in a positive (+) or negative (−) direction, intersects the second voltage reaches two.

5. The method according to claim 1, wherein the floating step is performed by turning off a plurality of switching devices provided in a sustain discharge circuit.

6. The method of claim 1, wherein a distance between a sustain electrode and an associated scan electrode is greater than or equal to 80 um.

7. A method of driving a plasma display device which comprises a plurality of scan electrodes and sustain electrodes, the method comprising:
applying a sustain pulse for a sustain discharge to the sustain electrodes or the scan electrodes during a sustain period;
increasing a voltage of the sustain electrodes or the scan electrodes from a first voltage to a second voltage; and
placing the sustain electrodes or the scan electrodes in a floating state after increasing the voltage.

8. The method of claim 7, wherein the first electrode is placed in the floating state for a predetermined period.

9. The method of claim 7, wherein the first electrode is placed in the floating state after the voltage level of the first electrode exceeds a predetermined value.

10. The method according to claim 7, wherein the floating step is performed to float the sustain electrodes or the scan electrodes if a number of times that the scan pluse, which intersects the second voltage in a positive (+) or negative (−) direction, intersects the second voltage reaches two.

11. The method according to claim 7, wherein the floating step is performed by turning off a plurality of switching devices provided in a sustain discharge circuit.

12. The method of claim 7, wherein a distance between a sustain electrode and an associated scan electrode is greater than or equal to 80 um.
